(19) United States
(12) Patent Application Publication
(10) Pub. No.: US 2015/0161076 A1
(43) Pub. Date: Jun. 11, 2015

(54) SOLUTION METHOD AND SOLUTION APPARATUS FOR UNDERDETERMINED SYSTEM OF LINEAR EQUATIONS

(71) Applicant: CANON KABUSHIKI KAISHA, Tokyo (JP)

(72) Inventor: Teruyoshi Washizawa, Atsugi-shi (JP)

(21) Appl. No.: 14/554,371

(22) Filed: Nov. 26, 2014

(30) Foreign Application Priority Data
Dec. 5, 2013 (JP) 2013-251767

(51) Int. Cl. G06F 17/12

(52) U.S. Cl. CPC G06F 17/12

(57) ABSTRACT

A variable to be determined is expressed as a product of a state variable and a structural variable for each element. The structural variable is a monotonically increasing function of a control variable that takes a real number value, and is thus limited to a real number of 0 to 1. An objective function defined as a function of the state variable and structural variable or the state variable and control variable is used. In each iteration, a computer executes: a state variable updating step of updating a value of each element of the state variable on the basis of information of the objective function with respect to the state variable; and a structural variable updating step of updating a value of each element of the structural variable on the basis of information of the objective function with respect to said structural variable.

### BACKGROUND OF THE INVENTION

1. Field of the Invention

The present invention relates to a solution method and a solution apparatus for solving a system of linear equations, and more particularly to a technique of solving an underdetermined system of linear equations in which the number of equations is smaller than the number of variables.

2. Description of the Related Art

In a medical instrument used for X ray computed tomography (CT), magnetic resonance imaging (MRI), or the like, a three-dimensional structure of the inside of a human body is reconstructed from an observation image projected onto a two-dimensional plane. When a three-dimensional structure to be estimated is set as an unknown vector x, an observation process such as X ray projection is set as a matrix A, and an observation signal is set as b, the observation process can be formulated as follows:

Ax=b (1)

Here, A may also be referred to as a coefficient matrix, and b may also be referred to as a constant vector or a right side vector.

When solving Equation (1), the number of observations is typically increased in order to improve the estimation precision of the three-dimensional structure. Hereafter, a dimension of a signal x to be estimated is set as N, a dimension of the observation signal b is set as M, and it is assumed that M<N. In Equation (1), the number M of equations is smaller than the dimension N of the variable, and therefore Equation (1) is referred to as an underdetermined system of linear equations.

An underdetermined system of linear equations has an infinite number of solutions, and therefore a solution is typically determined uniquely by applying a technique known as regularization.

In a recently proposed technique, an underdetermined system of linear equations is solved with a high degree of precision by assuming that the signal to be estimated is sparse (in other words, assuming that a majority of elements of the vector x are zero). This technique is known as sparse regularization, and is currently attracting attention as an effective technique for removing noise from images, reconstructing medical images, and so on, for example.

Algorithms of sparse regularization can be broadly divided into two types, namely a “greedy algorithm” and “L1 regularization”. A method exhibiting the most favorable performance with a greedy algorithm is subspace pursuit (abbreviated at SP hereafter), disclosed in Non-patent Literature (NPL) 1, and a method exhibiting the most favorable performance with L1 regularization is FISTA, disclosed in NPL 2.

In FISTA, Equation (1) is almost satisfied by searching a minimum point of an objective function defined by Equation (2) below, whereby a solution vector x having a small number of non-zero elements is obtained:

$${L}_{1} := ( \frac{1}{2} ) {‖ b - Ax ‖}_{2}^{2} + λ {‖ x ‖}_{1} \qquad ( 2 )$$

A first term of the objective function is an L2 norm of a residual vector of a system of equations. Further, a second term is a term obtained by multiplying a constant λ by an L1norm (a sum of absolute values of all elements of the vector x) of the solution vector x. This objective function L₁ has a property whereby the first term decreases as the solution vector x approaches one of the correct solutions of Equation (1), and the second term decreases as the solution vector x increases in sparsity (i.e. as the number of zero elements increases).

A flow of processing performed in FISTA will now be described using FIG. 3.

In step S301, variables x⁽⁰⁾ and y⁽¹⁾ are set at initial values, the number of iterations k is set at 1, and t⁽¹⁾ is set at 1. Note that the characters in superscript parentheses express the number of iterations.

In step S302, a step width β is determined. The inverse of the Lipschitz constant of ∇L₁:=∂L₁/∂x is set as the step width β, but as the dimension increases, the calculation time lengthens, and therefore an approximate value may be substituted. Note, however, that the approximate value must not exceed the inverse of the Lipschitz constant.

In step S303, a variable x^{(k)} is calculated using a following equation.

x^{(k)}=prox_{β}(y^{(k)}−β∇L₁(y^{(k)})) (3)

Here, prox_{β} is a function defined by following equations.

$$\begin{matrix}{prox}_{β} ( x ) := \{ \begin{matrix}sign ( x ) \vert x - β \vert , & if x > β \\ 0 , & otherwise\end{matrix} & ( 4 ) \\ sign ( x ) := \{ \begin{matrix}1 , & if x > 0 \\ 0 , & if x = 0 \\ - 1 , & if x < - 1\end{matrix} & ( 5 )\end{matrix}$$

In step S304, t^{(k+1)} is calculated using a following equation.

$${t}^{( k + 1 )} = \frac{1 + \sqrt{1 + 4 {( {t}^{( k )} )}^{2}}}{2} \qquad ( 6 )$$

In step S305, y^{(k+1)} is calculated using a following equation.

$${y}^{( k + 1 )} = {x}^{( k )} + \frac{{t}^{( k )} - 1}{{t}^{( k + 1 )}} ( {x}^{( k )} - {x}^{( k - 1 )} ) \qquad ( 7 )$$

Steps S303 to S305 are then repeated until a predetermined convergence condition is satisfied.

[Non-patent Literature 1] Wei Dai and Olgica Milenkovic: “Subspace Pursuit for Compressive Sensing Signal Reconstruction,” IEEE Transactions on Information Theory, VOL. 55, NO. 5, pp. 2230-2249, MAY 2009.

[Non-patent Literature 2] Amir Beck and Marc Teboulle: “A Fast Iterative Shrinkage-Thresholding Algorithm for Linear Inverse Problems,” SIAM Journal on Imaging Sciences, Vol. 2, No. 1, pp. 183-202, 2009.

### SUMMARY OF THE INVENTION

The performances of the two conventional solution methods SP and FISTA can be seen on a perfect reconstruction map shown in FIG. 4. The number of estimated signals N, or in other words the number of variables N, is 256. In FIG. 4, respective solution methods were used in relation to a matrix A generated in accordance with a normal distribution and ten correct solution cases, and a region in which nine cases had a relative error of no more than 5% was set as a perfect reconstruction region. The abscissa in the drawing shows a sparsity (=the number of non-zero elements/the number of estimation signals), and the ordinate shows an observation rate (=the number of observation signals/the number of estimation signals). Lines on the graph correspond to the respective solution methods, and an upper left region of the lines is the perfect reconstruction region. A line 401 shows a theoretical limit, a line 402 shows the limit of SP, and a line 403 shows the limit of FISTA. It is evident from the drawing that room remains for improvement in both methods in relation to the theoretical limit. A degree of variation in the observation rate relative to variation in the sparsity is particularly large in a region where the observation rate is small. This means that a large number of additional observation signals is required in response to even a small increase in the number of non-zero elements in the signal. In the case of a medical instrument used for X ray CT, MRI, or the like, for example, a measurement time is preferably shortened by reducing the number of observations in order to lighten physical and psychological loads on a subject. In practical terms, therefore, it is extremely important to reduce the required number of observation signals.

The present invention has been designed in consideration of this problem, and an object thereof is to provide a solution technique with which a higher degree of estimation precision can be realized at a smaller observation rate (with a smaller number of observation signals).

The present invention in its first aspect provides a solution method for solving an underdetermined system of linear equations using iterative calculations performed by a computer, wherein a variable to be determined is expressed as a product of a state variable, which represents a value of each element of said variable, and a structural variable, which represents a non-zero element probability of each element of said variable, for each element, said structural variable is a monotonically increasing function of a control variable that takes a real number value, and is thus limited to a real number not smaller than 0 and not larger than 1, an objective function defined as a function of said state variable and structural variable or said state variable and control variable is used, and in each iteration, said computer executes: a state variable updating step of updating a value of each element of said state variable on the basis of information of said objective function with respect to said state variable; and a structural variable updating step of updating a value of each element of said structural variable on the basis of information of said objective function with respect to said structural variable.

The present invention in its second aspect provides a solution apparatus for solving an underdetermined system of linear equations using iterative calculations, a variable to be determined being expressed as a product of a state variable, which represents a value of each element of said variable, and a structural variable, which represents a non-zero element probability of each element of said variable, for each element, and said structural variable being a monotonically increasing function of a control variable that takes a real number value, and is thus limited to a real number not smaller than 0 and not larger than 1, said solution apparatus comprising: a calculating unit configured to perform said iterative calculations using an objective function defined as a function of said state variable and structural variable or said state variable and control variable, wherein in each iteration, said calculating unit executes: a state variable updating step of updating a value of each element of said state variable on the basis of information of said objective function with respect to said state variable; and a structural variable updating step of updating a value of each element of said structural variable on the basis of information of said objective function with respect to said structural variable.

The present invention in its third aspect provides a subject information acquisition apparatus for reconstructing image data representing information relating to an inside of a subject from observation data obtained by an observation system, comprising: a data obtaining unit configured to obtain data representing characteristics of said observation system and said observation data obtained by said observation system; and the solution apparatus for an underdetermined system of linear equations according to the present invention, wherein said solution apparatus calculates a solution to a system of linear equations Ax=b, where said data representing said characteristics of said observation system are set as a matrix A, said observation data obtained by said observation system are set as a constant vector b, and said image data representing said information relating to said inside of said subject are set as an unknown variable x.

The present invention in its fourth aspect provides a non-transitory computer readable storage medium, storing a program for causing a computer to execute said respective steps of said solution method for an underdetermined system of linear equations according to the present invention.

According to the present invention, a solution technique with which a higher degree of estimation precision can be realized at a smaller observation rate (with a smaller number of observation signals) can be provided.

Further features of the present invention will become apparent from the following description of exemplary embodiments with reference to the attached drawings.

### BRIEF DESCRIPTION OF THE DRAWINGS

FIG. 1 is a flowchart showing processing of a solution method according to an embodiment of the present invention;

FIG. 2 is a block diagram showing a configuration of a solution apparatus according to this embodiment of the present invention;

FIG. 3 is a flowchart showing an example of calculation processing performed in FISTA;

FIG. 4 is a perfect reconstruction map showing respective performances of a conventional technique and the solution method according to this embodiment of the present invention; and

FIG. 5 is a view showing an example of a configuration of a subject information acquisition apparatus to which the solution method according to the present invention is applied.

### DESCRIPTION OF THE EMBODIMENTS

The present invention relates to a solution technique for solving an underdetermined system of linear equations Ax=b by performing iterative calculations using a computer, and proposes an improved algorithm for the sparse regularization method described above.

A feature of this method is that the sparsity of a variable x to be determined (an N-dimensional vector having N elements) is evaluated by expressing the variable x as a product of a state variable s representing a value of each element of x and a structural variable ρ representing a non-zero element probability of each element of x (i.e. the probability that each element is a non-zero element) for each element. The structural variable ρ is independent of the state variable s. Similarly to the variable x, both the structural variable ρ and the state variable s are expressed as N-dimensional vectors having N elements. The structural variable ρ has a probabilistic property, and is therefore limited to a real number not smaller than 0 and not larger than 1. Hence, to simplify usage during differentiation or the like, a control variable ν that takes a real number value is introduced, and the structural variable ρ is defined as a monotonically increasing function thereof using a following equation, for example.

ρⱼ:=(1+exp(−θνⱼ))⁻¹ (8)

A coefficient θ in Equation (8) is a parameter for determining a gradient of the structural variable ρ, and is preferably set as a monotonically increasing function of the number of iterations t. The coefficient θ is given by a following equation, for example (where θ₀ is an initial value).

$$θ := {θ}_{0} \frac{log ( t + 2 )}{log ( {t}_{MAX} + 2 )} \qquad ( 9 )$$

From the variable ρ in Equation (8), the non-zero element probability of each element of the state variable s can be expressed by a normalized value between 0 and 1 (where 0 is a zero element and 1 is a non-zero element). By gradually increasing the value of the coefficient θ as the number of iterations t increases, the structural variable ρ is more likely to take an intermediate value between 0 and 1 during an initial stage of the iterative calculations in which zero elements and non-zero elements are unclear, and as the iterative calculations advance, convergence of the structural variable ρ on 0 or 1 can be promoted.

Using Equation (8), the structural variable ρ can be determined uniquely by the control variable ν. Therefore, updating and differentiation of the structural variable ρ and updating and differentiation of the control variable ν may be described as being equivalent hereafter.

In this method, an objective function L₂ (s, ρ) defined as a function of the state variable s and the structural variable ρ is used (the structural variable ρ is a function of the control variable ν, and therefore the objective function L₂ can be expressed as a function L₂ (s, ν) of the state variable s and the control variable ν). More specifically, during each iteration, (1) a state variable updating step of updating the value of each element of the state variable s is executed on the basis of “information of L₂ with respect s”, and (2) a structural variable updating step of updating the value of each element of the structural variable ρ is executed on the basis of “information of L₂ with respect to ρ”. In the structural variable updating step, the value of each element of the control variable ν is preferably updated first, whereupon the value of each element of the structural variable ρ is updated using Equation (8).

In the conventional FISTA method, as shown in Equation (2), the sparsity of the solution vector is evaluated by introducing the L1 norm of the solution vector into the second term of the objective function L₁. With the L1 norm of the second term, however, it is impossible to determine whether the value of the solution vector itself is small (a signal level is small, for example) or the solution vector includes a large number of zero elements. Therefore, the value of the objective function L₁ is affected by the value of the solution vector itself, and as a result, an estimation precision and a convergence ability may deteriorate. With this method, on the other hand, the sparsity of the state variable s is evaluated using the structural variable ρ, which is independent of the state variable s. Hence, the magnitude of the value of the state variable s can be prevented from affecting the objective function L₂, enabling improvements in the estimation precision and the convergence ability in comparison with the conventional methods.

A partial differentiation (∂L₂/∂s) of the objective function L₂ with respect to the state variable s is preferably used as the “information of L₂ with respect to s”. In so doing, it is possible to determine directly whether to vary the state variable s in a positive direction or a negative direction in order to reduce the value of the objective function L₂. When the objective function L₂ cannot be differentiated or cannot easily be differentiated, a numerical differentiation may be used instead of the partial differentiation. A numerical differentiation is an operation to calculate a differentiation relating to s in L₂ approximately from a difference between a value L₂ (s+Δs, ρ) of the objective function when the value of the state variable s is shifted by a small amount Δs and L₂ (s, ρ). Instead of the numerical differentiation, any value that is equivalent to or correlates with a differentiation of L₂ in relation to s may be used favorably as the “information of L₂ with respect to s”.

A partial differentiation (∂L₂/∂ν) of the objective function L₂ in relation to the control variable ν is preferably used as the “information of L₂ with respect to ρ”. In so doing, it is possible to determine directly whether to vary the control variable ν in a positive direction or a negative direction in order to reduce the value of the objective function L₂. When the objective function L₂ cannot be differentiated or cannot easily be differentiated, a numerical differentiation may be used instead of the partial differentiation. A numerical differentiation is an operation to calculate a differentiation relating to ν in L₂ approximately from a difference between a value L₂ (s, ν+Δν) of the objective function when the value of the control variable ν is shifted by a small amount Δν and L₂ (s, ν). Instead of the numerical differentiation, any value that is equivalent to or correlates with a differentiation of L₂ in relation to ν may be used favorably as the “information of L₂ with respect to ρ”.

### Embodiment

A preferred embodiment of the solution method and solution apparatus according to the present invention will be described in detail below with reference to the drawings.

(Configuration of Solution Apparatus)

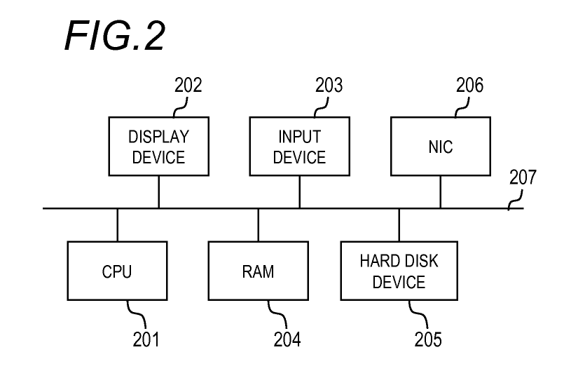

FIG. 2 is a block diagram showing a basic configuration of a computer that functions as a solution apparatus according to an embodiment of the present invention. The computer is mainly constituted by a CPU 201, a display device 202, an input device 203, a RAM 204, a hard disk device 205, an NIC 206, and so on, which are connected to each other via a bus 207.

The CPU (Central Processing Unit) 201 performs overall control of the apparatus using programs and data stored in the RAM (a main memory) 204, and executes various processing described below. The display device 202 is constituted by a liquid crystal display or the like, and is capable of displaying processing results (an obtained solution, a reconstructed image) obtained by the CPU 201 in the form of alphanumerical characters, images, and so on. The input device 203 is constituted by an operating device such as a keyboard or a mouse, and is capable of inputting various instructions into the CPU 201. The RAM 204 includes an area for temporarily storing programs and data loaded from the hard disk device 205, and a work area required by the CPU 201 to execute various processing. An operating system (OS), and programs and data for causing the CPU 201 to execute the various processing, described below, to be performed by the computer are stored in the hard disk device 205. These programs are loaded to the RAM 204 and executed by the CPU 201, whereby the computer functions as a solution apparatus for numerically solving a system of equations. The network interface controller (NIC) 206 functions as an interface during data communication with an external apparatus. The computer exchanges programs and data with the external apparatus via the NIC 206.

Note that instead of the programs and data stored in the hard disk device 205, programs and data received from an external apparatus via the NIC 206 may be used in the processing executed by the CPU 201. In other words, the solution apparatus may employ a system configuration such as a client server, cloud computing, or grid computing. Alternatively, the functions of the solution apparatus may be packaged in a built-in computer installed in a medical instrument or an image analysis instrument. Alternatively, all or a part of the functions of the solution apparatus may be constituted by a circuit such as an ASIC or an FPGA.

(Solution Method)

Next, a method of solving an underdetermined system of linear equations according to this embodiment will be described.

In this embodiment, when the system of linear equations Ax=b to be solved is given, an objective function L₂ defined by a following equation is used.

$${L}_{2} ( s , v ) := ( \frac{1}{2} ) {‖ b - A ( ρ ⊗ s ) ‖}_{2}^{2} + {λ}_{1} {\sum }_{j = 1}^{N} {ρ}_{j} + {λ}_{2} {\sum }_{j = 1}^{N} {ρ}_{j} ( 1 - {ρ}_{j} ) \qquad ( 10 )$$

where
x:=ρ [symbol] s:=(ρ₁, ρ₂, . . . , ρ_{N})^{T} [symbol] (s₁, s₂, . . . , s_{N})^{T}:=(ρ₁s₁, ρ₂s₂, . . . , ρ_{N}s_{N})^{T}
s:=(s₁, s₂, . . . , s_{N})^{T}
ν:=(ν₁, ν₂, . . . , ν_{N})^{T}
ρ:=(ρ₁, ρ₂, . . . , ρ_{N})^{T}
N: a number of elements
λ₁, λ₂: coefficients (constants)

A first term of the objective function L₂ in Equation (10) is the square of the L2 norm of the residual vector of the system of equations. The first term takes a steadily smaller value as each element (in other words, the product of the state variable s and the structural variable ρ for each element) of the solution vector x approaches the correct solution. Further, a second term of the objective function L₂ corresponds to a sum of the variable ρ, and takes a steadily smaller value as the solution vector x increases in sparsity (i.e. as the number of zero elements increases). Furthermore, a third term corresponds to a sum of a product of the variable ρ and (1−ρ), and takes a steadily smaller value as the variable ρ approaches 0 or 1 (i.e. as division into zero elements and non-zero elements advances). The coefficients λ₁, λ₂ are parameters for adjusting a weighting. By using this objective function L₂, extraction of the non-zero elements and retrieval of a more favorable solution can be achieved efficiently. Further, since the values of the second term and the third term for evaluating the sparsity are not affected by the solution vector x, problems such as those of FISTA do not arise.

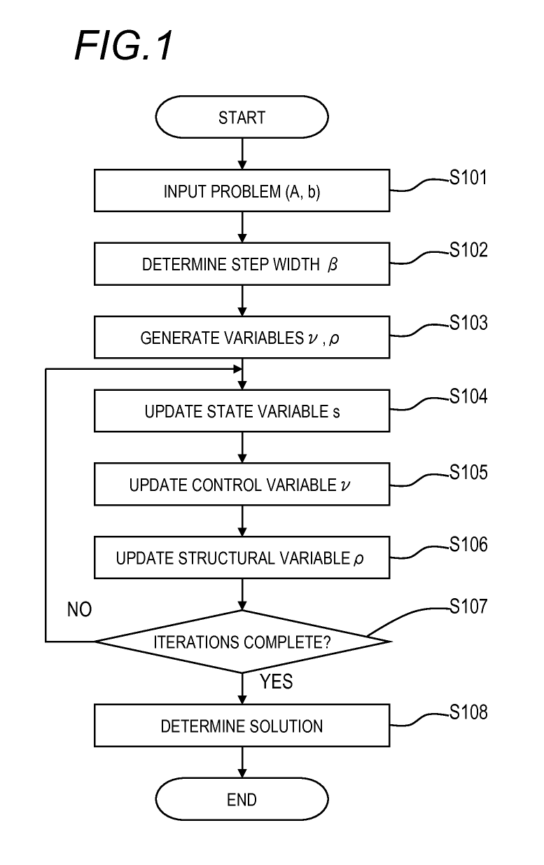

FIG. 1 is a flowchart showing a flow of solution processing executed by the solution apparatus. A main body for executing the processing shown in FIG. 1 is the CPU (calculating unit) 201 of the solution apparatus.

In step S101, the CPU 201 sets a problem input by a user, or in other words the value of the coefficient matrix A and the value of the constant vector b. Further, the CPU 201 secures a memory area for the state variable s, and sets the state variable s at an initial value.

In step S102, the CPU 201 sets a step width βₛ of the state variable s and a step width β_{ν} of the control variable ν. In this embodiment, the step widths βₛ and ρ_{ν} are determined using following equations.

βₛ≦1.999/Lip(∇L₂) (11)

β_{ν}≦1.999/(Lip(∇L₂)+λ₁+λ₂) (12)

Here, Lip (∇L₂) is the Lipschitz constant of a gradient of the objective function L₂ shown in Equation (10).

In step S103, the CPU 201 secures a memory area for the control variable ν and the structural variable ρ, and sets the control variable ν and the structural variable ρ at initial values. Further, the CPU 201 sets the number of iterations k at 1.

When the initialization processing described above is complete, the CPU 201 executes iterative calculations of steps S104 to S106 repeatedly.

Step S104 is the state variable updating step of updating the value of each element sⱼ of the state variable s. In this embodiment, the CPU 201 calculates s^{(k+1)} from the state variable s^{(k)} using a following equation.

s^{(k+1)}=s^{(k)}+βₛΔs^{(k+1)} (13)

Here, Δs^{(k+1)} is a differentiation of the objective function L₂ with respect to the state variable s, which takes a value determined using a following equation.

Δs^{(k+1)}=−(ρ^{(k)} [symbol] (A^{T}(b−A(ρ^{(k)} [symbol] s^{(k)})))) (14)

Step S105 is the structural variable updating step of updating the value of each element ρⱼ of the structural variable ρ. In this embodiment, first, the CPU 201 calculates ν^{(k+1)} from the control variable ν^{(k)} using a following equation.

ν^{(k+1)}=ν^{(k)}+β_{ν}Δν^{(k+1)} (15)

Here, Δν^{(k+1)} is a differentiation of the objective function L₂ with respect to the control variable ν, which takes a value determined using a following equation.

$$Δ {v}^{( k + 1 )} = - ( {s}^{( k )} ⊗ ( {A}^{T} ( b - A ( {ρ}^{( k )} ⊗ {s}^{( k )} ) ) ) ) + θ ( {λ}_{1} + {λ}_{2} ( 1 - 2 {ρ}^{( k )} ) ) ⊗ {ρ}^{( k )} ⊗ ( 1 - {ρ}^{( k )} ) \qquad ( 16 )$$

Further, the CPU 201 calculates the structural variable ρ^{(k+1)} from the control variable ν^{(k+1)} using Equation (8).

Step S107 is a step of determining whether or not the iterative calculations are complete. The CPU 201 evaluates whether or not a state of the iterative calculations satisfies a predetermined convergence condition. When the convergence condition is not satisfied, the CPU 201 increments the number of iterations k and then returns to step S104. When the convergence condition is satisfied, the CPU 201 exits the iterative calculations and advances to step S108. The convergence condition maybe determined to be satisfied when, for example, the value of the objective function L₂ falls below a predetermined threshold, a value of a residual norm (corresponding to the first term of the objective function L₂) of the system of linear equations falls below a predetermined threshold, the number of iterations k reaches a predetermined number, and so on. Alternatively, a convergence condition combining at least two of the objective function, the residual norm, and the number of iterations may be set. A combination is a logical product or a logical sum of a plurality of conditions (propositions). For example, the convergence condition may be determined to be satisfied when “the number of iterations exceeds a predetermined number and the value of the objective function falls below a threshold”, or when “the value of the objective function falls below a first threshold or the value of the residual norm falls below a second threshold”. Alternatively, the convergence condition may be determined to be satisfied when the values of the objective function and the residual norm are smaller than a threshold a plurality of times.

Step S108 is a step of determining the solution to the system of linear equations following completion of the iterative calculations. Most simply, the value of the product of the state variable s and the structural variable ρ for each element obtained in the final iterative calculation may be selected as the solution to the equation. Alternatively, the CPU 201 may store the variables s, ρ at which the value of the objective function L₂ or the residual norm is minimized, from among the iterative calculations performed in steps S104 to S106, in a memory, and output the value of the product of the variables s and ρ for each element at that time as an optimum solution.

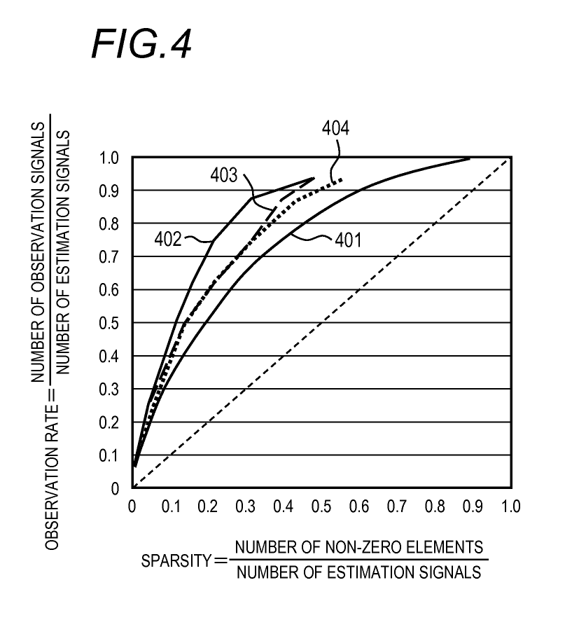

By performing the processing described above, the solution to an underdetermined system of linear equations can be determined with a high degree of precision. The performance of the solution method according to this embodiment is shown on a line 404 on the perfect reconstruction map of FIG. 4. The performance (404) of the method according to this embodiment is closer to the theoretical limit (401) than the conventional methods SP (402) and FISTA (403). In particular, it can be seen that reconstruction is possible when the sparsity is in the vicinity of 0.1 and 0.4, where reconstruction is impossible with the conventional methods.

### MODIFIED EXAMPLE

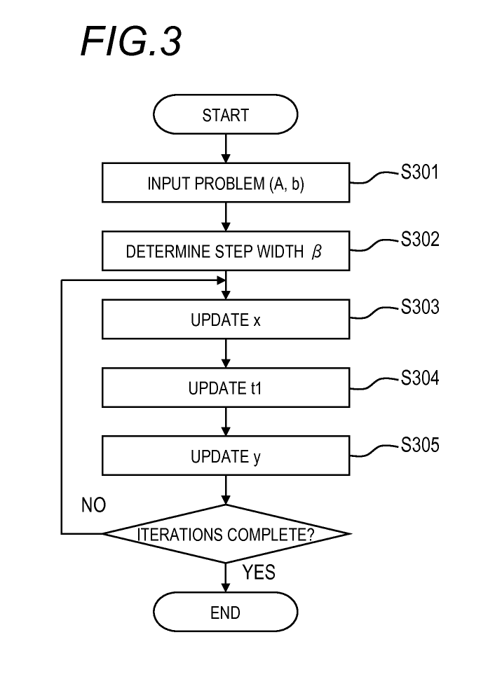

In the flow of FIG. 3, the processing (Equation (13)) for updating the state variable s in the state variable updating step S104 is executed only once, but the updating processing of step S104 is preferably executed a plurality of times. In other words, the value of the state variable s is updated a plurality of times while the value of the structural variable ρ remains fixed. In so doing, a more favorable performance may be obtained. The number of updates may be set in advance at five or ten, for example, or maybe varied dynamically. As a method of dynamically varying the number of updates, repetition of the updating processing may be stopped on the basis of the values of the objective function L₂ and the residual norm, variation rates thereof, and so on, for example, similarly to the condition determination of step S107.

The processing for updating the structural variable ρ in the structural variable updating step S105 is likewise preferably executed a plurality of times. In other words, the value of the structural variable ρ is updated a plurality of times while the value of the state variable s remains fixed. In so doing, a more favorable performance may be obtained. As described above, the number of updates may be set in advance or varied dynamically on the basis of the objective function L₂, the residual norm, and so on.

(Example of Application)

An example in which the solution method according to this embodiment is applied to image reconstruction processing in a subject information acquisition apparatus will now be described. The subject information acquisition apparatus is an apparatus that reconstructs image data representing information relating to the inside of a subject from observation data obtained by an observation system, for example a medical image diagnosis apparatus (an X ray CT apparatus, an MRI apparatus, a photoacoustic tomography apparatus, an ultrasound diagnosis apparatus, and so on) or a non-destructive examination apparatus.

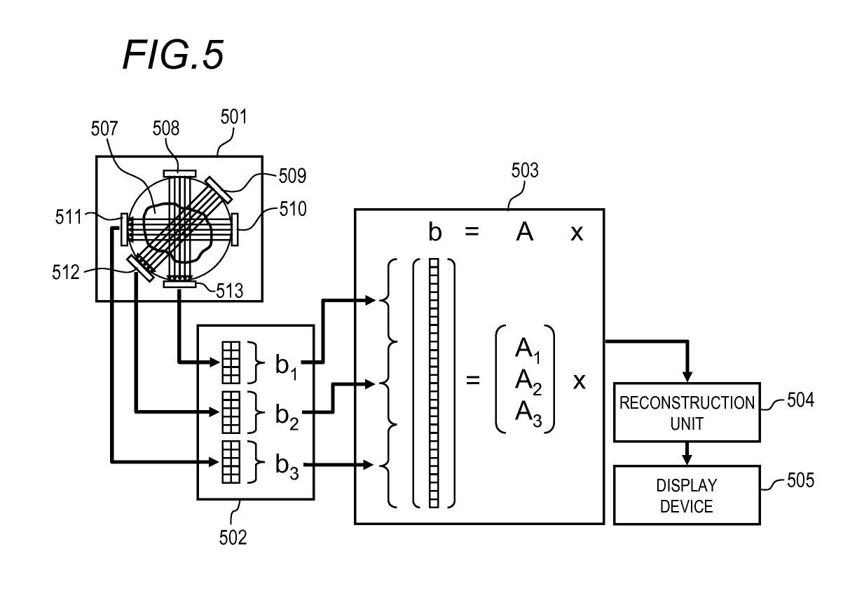

FIG. 5 is a schematic view showing a configuration of a medical image diagnosis apparatus installed with the solution apparatus according to this embodiment. As shown in the drawing, the medical image diagnosis apparatus includes an observation system (a measurement apparatus) 501, a projection data generation unit 502, a data acquisition unit 503, a reconstruction unit 504, a display device 505, and so on.

The observation system 501 includes a measurement apparatus casing 506, signal generators 508, 509, 510, and detectors 511, 512, 513. The signal generators 508, 509, 510 are apparatuses that irradiate a subject 507 disposed inside the casing 506 with measurement signals. For example, the signal generators 508, 509, 510 are X ray sources in the case of X ray CT, magnetic field generators in the case of MRI, laser beam sources in the case of photoacoustic tomography, and ultrasonic wave generators in the case of an ultrasound diagnosis apparatus. Signals that pass through the subject 507 or signals that are generated in or reflected by the interior of the subject 507 are detected by the detectors 511, 512, 513.

The projection data generation unit 502 groups the signals detected by the plurality of detectors 511, 512, 513 into a single set of observation data in accordance with a predetermined format. For example, the detected signals are grouped together into a vector representation obtained from a raster scan of a two-dimensional image. As a result, respective detected signals b₁, b₂, b₃ are integrated into a single vector b.

The data acquisition unit 503 creates the system of equations Ax=b from the observation data (the vector b) obtained from the projection data generation unit 502 and data (the coefficient matrix A) expressing characteristics of the observation system 501, which are stored in advance. Here, x is an unknown variable and an N-dimensional vector. The coefficient matrix A may be created logically on the basis of physical characteristics of the signal generators and detectors constituting the observation system 501 and so on, or may be created from results obtained by actually measuring a sample having a known internal structure using the observation system 501. A₁, A₂, A₃ in FIG. 5 denote characteristics of the signal generator 508 and the detector 511, characteristics of the signal generator 509 and the detector 512, and characteristics of the signal generator 510 and the detector 513, respectively.

The reconstruction unit 504 determines the unknown variable x using the solution method shown in FIG. 1. The reconstruction unit 504 then generates image data representing the internal structure of the subject 507 on the basis of the obtained solution to the unknown variable x. The generated data are displayed on the display device 505. At this time, either a cross-section (a two-dimensional image) of the subject or the three-dimensional structure of the inside of the subject may be displayed. Operations such as turning and translating the image may be instructed at this time using a user interface.

Incidentally, the solution method according to this embodiment is based on the premise that the majority of the unknown variables x are considered to be zero elements. Hence, when the sparsity of the unknown variable x is insufficient, the estimation precision of the solution may deteriorate and so on such that the expected performance is not obtained. In response to this problem, the data acquisition unit 503 may create a system of equations (A Φ⁻¹) z=b using a coefficient matrix (A Φ⁻¹) instead of the coefficient matrix A, whereupon the reconstruction unit 504 determines an unknown variable z using the solution method shown in FIG. 1 and then calculates the original unknown variable x from x=Φ⁻¹ z. Φ is a characteristic quantity conversion matrix that exhibits an action for increasing the sparsity of the unknown variable x. In other words, z=Φ x, which is a variable obtained when the conversion matrix Φ is applied to the unknown variable x, has a higher sparsity than the variable x, and therefore a solution can be obtained more easily using the method according to this embodiment. A filter that increases the number of zero elements in the image data (the variable x) representing the information relating to the inside of the subject, for example a differential filter, a secondary differential filter, a high pass filter, a cutoff filter, or the like, may be used as the conversion matrix Φ. With this method, a further improvement in the precision of image reconstruction can be expected.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-251767, filed on Dec. 5, 2013, which is hereby incorporated by reference herein in its entirety.

What is claimed is:

1. A solution method for solving an underdetermined system of linear equations using iterative calculations performed by a computer, wherein
a variable to be determined is expressed as a product of a state variable, which represents a value of each element of said variable, and a structural variable, which represents a non-zero element probability of each element of said variable, for each element,
said structural variable is a monotonically increasing function of a control variable that takes a real number value, and is thus limited to a real number not smaller than 0 and not larger than 1,
an objective function defined as a function of said state variable and structural variable or said state variable and control variable is used, and
in each iteration, said computer executes:
a state variable updating step of updating a value of each element of said state variable on the basis of information of said objective function with respect to said state variable; and
a structural variable updating step of updating a value of each element of said structural variable on the basis of information of said objective function with respect to said structural variable.

2. The solution method for an underdetermined system of linear equations according to claim 1, wherein said information of said objective function with respect to said state variable is a partial differentiation or a numerical differentiation of said objective function with respect to said state variable.

3. The solution method for an underdetermined system of linear equations according to claim 1, wherein said information of said objective function with respect to said structural variable is a partial differentiation or a numerical differentiation of said objective function with respect to said control variable.

4. The solution method for an underdetermined system of linear equations according to claim 1, wherein, in said state variable updating step, processing for updating said value of each element of said state variable is executed a plurality of times.

5. The solution method for an underdetermined system of linear equations according to claim 1, wherein, in said structural variable updating step, processing for updating said value of each element of said structural variable is executed a plurality of times.

6. The solution method for an underdetermined system of linear equations according to claim 1, wherein, in each iteration, said computer executes a step of determining whether or not said iterative calculations are complete on the basis of whether or not a convergence condition, which is constituted by a value of said objective function, a residual norm of said system of linear equations, the number of iterative calculations, or a combination of two or more thereof, is satisfied.

7. The solution method for an underdetermined system of linear equations according to claim 1, wherein, when said iterative calculations are complete, said computer executes a step of determining a value at which said value of said objective function or said residual norm of said system of linear equations is minimized, from among values of said state variable obtained in each iteration, as a solution to said system of linear equations.

8. The solution method for an underdetermined system of linear equations according to claim 1, wherein, when said variable to be determined is x, said state variable is s, said structural variable is ρ, said control variable is ν, and said system of linear equations to be solved is Ax=b, an objective function L₂ is defined by a following equation:
$${L}_{2} ( s , v ) := ( \frac{1}{2} ) {‖ b - A ( ρ ⊗ s ) ‖}_{2}^{2} + {λ}_{1} {\sum }_{j = 1}^{N} {ρ}_{j} + {λ}_{2} {\sum }_{j = 1}^{N} {ρ}_{j} ( 1 - {ρ}_{j} )$$
where
A: a coefficient matrix of the system of linear equations
b: a constant vector of the system of linear equations
x:=ρ [symbol] s:=(ρ₁, ρ₂, . . . , ρ_{N})^{T} [symbol] (s₁, s₂, . . . , s_{N})^{T}:=(ρ₁s₁, ρ₂s₂, . . . , ρ_{N}s_{N})^{T}
s:=(s₁, s₂, . . . , s_{N})^{T}
ν:=(ν₁, ν₂, . . . , ν_{N})^{T}
ρ:=(ρ₁, ρ₂, . . . , ρ_{N})^{T}
ρⱼ:=(1+exp(−θνⱼ))⁻¹
N: a number of elements, and
λ₁, λ₂, θ: coefficients.

9. The solution method for an underdetermined system of linear equations according to claim 8, wherein a value of said coefficient θ increases monotonically in accordance with said number of iterations.

10. A solution apparatus for solving an underdetermined system of linear equations using iterative calculations,
a variable to be determined being expressed as a product of a state variable, which represents a value of each element of said variable, and a structural variable, which represents a non-zero element probability of each element of said variable, for each element, and
said structural variable being a monotonically increasing function of a control variable that takes a real number value, and is thus limited to a real number not smaller than 0 and not larger than 1,
said solution apparatus comprising:
a calculating unit configured to perform said iterative calculations using an objective function defined as a function of said state variable and structural variable or said state variable and control variable, wherein
in each iteration, said calculating unit executes:
a state variable updating step of updating a value of each element of said state variable on the basis of information of said objective function with respect to said state variable; and
a structural variable updating step of updating a value of each element of said structural variable on the basis of information of said objective function with respect to said structural variable.

11. A subject information acquisition apparatus for reconstructing image data representing information relating to an inside of a subject from observation data obtained by an observation system, comprising:
a data obtaining unit configured to obtain data representing characteristics of said observation system and said observation data obtained by said observation system; and
the solution apparatus for an underdetermined system of linear equations according to claim 10, wherein
said solution apparatus calculates a solution to a system of linear equations Ax=b, where said data representing said characteristics of said observation system are set as a matrix A, said observation data obtained by said observation system are set as a constant vector b, and said image data representing said information relating to said inside of said subject are set as an unknown variable x.

12. The subject information acquisition apparatus according to claim 11, wherein said solution apparatus solves a variable z in a system of linear equations (A Φ⁻¹) z=b using a conversion matrix Φ given in advance, and then determines said variable x from x=Φ⁻¹ z.

13. The subject information acquisition apparatus according to claim 12, wherein said conversion matrix Φ is a filter that increases the number of zero elements in said image data representing said information relating to said inside of said subject.

14. A non-transitory computer readable storage medium, storing a program for causing a computer to execute said respective steps of said solution method for an underdetermined system of linear equations according to claim 1.
